(19) United States
(12) Patent Application Publication
(10) Pub. No.: US 2013/0170522 A1
(43) Pub. Date: Jul. 4, 2013

(54) Method for Securing Communications Using an Initialization Vector the Time Not Being Known

(71) Applicant: THALES, Neuilly-sur-Seine (FR)

(72) Inventor: Patrick BRUAS, Gennevilliers (FR)

(73) Assignee: THALES, Neuilly-sur-Seine (FR)

(21) Appl. No.: 13/728,832

(22) Filed: Dec. 27, 2012

(30) Foreign Application Priority Data
Dec. 29, 2011 (FR) 11 04129

(51) Int. Cl. H04B 1/7136

(52) U.S. Cl. CPC H04B 1/7136
USPC 375/133

(57) ABSTRACT

A method for securing communications in a network comprising at least one emitter terminal A and one receiver terminal B, comprises in combination at least the following steps: defining a measurable quantity that can be measured at the emitter A and the receiver B; normalizing and quantifying said defined quantity; initializing an initialization vector with said normalized and quantified quantity; using said initialization vector with a cryptographic key to randomly generate a set of consecutive frequencies to use for securing said communications between the emitter A and the receiver B; and incrementing the initialization vector by a given value after each pseudo-random generation time interval Itpa in order to generate a set of consecutive frequency values.

### CROSS-REFERENCE TO RELATED APPLICATION

This application claims priority to foreign French patent application No. FR 1104129, filed on Dec. 29, 2011, the disclosure of which is incorporated by reference in its entirety.

### FIELD OF THE INVENTION

The invention relates to a method allowing communications to be protected or secured via use of an initialization vector, the time not typically being known when implementing the method.

The method is applicable, for example, to any protected communications, whatever the spread spectrum used.

The method is especially applicable to the field of satellite telecommunications.

### BACKGROUND

In the general field of protected radio communications, the receiver must have its spread code synchronized with that of the emitter in order to receive traffic, and if possible passively, i.e. without the emission of a signal over the radio channel.

The “spread code” used is a pseudo-random function obtained by virtue of a code generator that is initialized with a cryptographic key and an initialization vector also called a “marker”. The emitter and the receiver share the same key. In the case where the initialization vector is not transmitted over the radio channel, the initialization vector is called an “implicit initialization vector”. In the contrary case, this “initialization vector” is transmitted over a radio channel, in what is called a “degraded” procedure, and the vector is called an “explicit initialization vector”.

In methods known in the art, the “initialization vector” is regularly incremented over a time base formed of a series of consecutive time intervals that are of identical duration. In the prior art, the initialization vector is delivered with “time” information and the initialization vector is incremented after each time interval in said series, a time interval corresponding to a set of FHSS (frequency-hopping spread spectrum) stages starting at an initial time T₀ which is chosen by convention as is known in the art.

The time is then used to number the initialization vector values. For example, in the frequency-hopping spread spectrum (or FHSS) technique, context changes, corresponding to a new generation of a pseudo-random number serving to select the hop frequency, take place after each time interval, called the “pseudo-random generation interval”, Itpa. Thus, the initialization vector is incremented by 1 after each interval Itpa. The number scale of the initialization vectors starts at a date T₀ established by convention for the communication network. The traffic emitter executes a rapid hopping function in the time/frequency domain.

Each subscriber to the network needs to possess a time source, for example a GPS (global positioning system) receiver, an atomic or GMT clock, etc. or more generally a reliable, stable and precise means for telling the time in order for the time to be known with a certain known precision ΔT relative to a “network reference time”, i.e. the time of the master clock of the network, i.e. a standard time scale such as coordinated universal time (UTC) or even the continuous time scale used internally by the GPS which therefore excludes the leap seconds of UTC. The greater the precision, the shorter the time taken to access the network.

When a station of the network does not know the time, it is necessary to distribute the time to the station that lacks it, thereby degrading the quality of the radio-channel time acquisition procedures. To do this, known prior art methods employ a lower-security time beacon, for example a periodic function or a slowly-varying function based on a code validity interval (or CVI), or even a procedure in which the accessing station must make a time request over a radio channel, requiring the station to emit.

FIG. 1 shows an exemplary embodiment of methods according to the prior art. A terminal A is in an emitting state. The terminal A comprises a key and a time source 10, from which an initialization vector VI is produced serving to generate, using the key K, a spread code in the time/frequency domain. The key and the initialization vector are delivered to a module for generating a pseudo-random number that is used to select the hop frequency that will be applied 11 to the communication to be transmitted. The secure communication arrives at the receiver of the terminal B, which is in a receiving state, the receiver will despread the communication using the same spread code based on the same initialization vector VI produced using the same key K and the same pseudo-random number generating module.

To provide the receiver of the terminal B with an initialization vector with a suitable value, prior-art methods either make use of a local time source or a time source accessed over a radio channel.

In certain applications, the local time source is not 100% reliable. The drawback of a time source accessed over a radio channel is that either an active method is used, which will therefore have an electromagnetic signature, or a passive method is used, degrading the ECCM quality of the frequency-hopping spread spectrum signal.

### SUMMARY OF THE INVENTION

The present invention includes completely dispensing with the need to know the time during normal use of the method and system according to the invention.

In the rest of the description, the expression “measurable quantity” is understood to have the meaning used in mathematics or physics. A quantity may be said to be measurable or immeasurable. The measurement expresses the magnitude of a measurable object so as to allow this magnitude to be compared with other magnitudes of the same nature.

The concept of quantity is used in mathematics to denote notions associated with various characteristics such as length, areas, volumes, masses, angles, speeds, durations, vectors, statistical or random data distributions, etc.

The subject of the invention is a method for securing communications in a network comprising at least one emitter terminal A and one receiver terminal B, noteworthy in that it comprises in combination at least the following steps:
1) defining a measurable quantity that can be measured at the emitter A and the receiver B;
2) normalizing and quantifying said defined quantity;
3) initializing an initialization vector with said normalized and quantified quantity;
4) using said initialization vector with a cryptographic key to randomly generate a set of consecutive frequencies to use for securing said communications between the emitter A and the receiver B; and
5) incrementing the initialization vector by a given value after each pseudo-random generation time interval Itpa in order to generate a set of consecutive frequency values.

The receiver terminal for example carries out a synchronization search using a wait function the duration of the wait stage of which is based on the duration of the time interval Itpa.

The method may use, as the measurable value, a function of the conventional mechanical variation in distance of a geostationary satellite inclined relative to any station located at a non-zero latitude.

### BRIEF DESCRIPTION OF THE DRAWINGS

Other features and advantages of the device according to the invention will become more clearly apparent on reading the following description of an embodiment, given by way of illustration and completely non-limiting example, and the appended figures which show:

FIG. 1, a schematic showing the principles of prior-art protected communications;

FIG. 2, an example of a system architecture for protected communications according to the invention;

FIG. 3, an illustration of a frequency-hopping spread spectrum wait function, on a graph where the X-axis corresponds to the initialization vector VI; and

FIG. 4, an exemplary measurable quantity used as an initialization vector.

### DETAILED DESCRIPTION

In order to better understand the principle employed by the invention, the example that follows is given merely by way of illustration and is completely non-limiting.

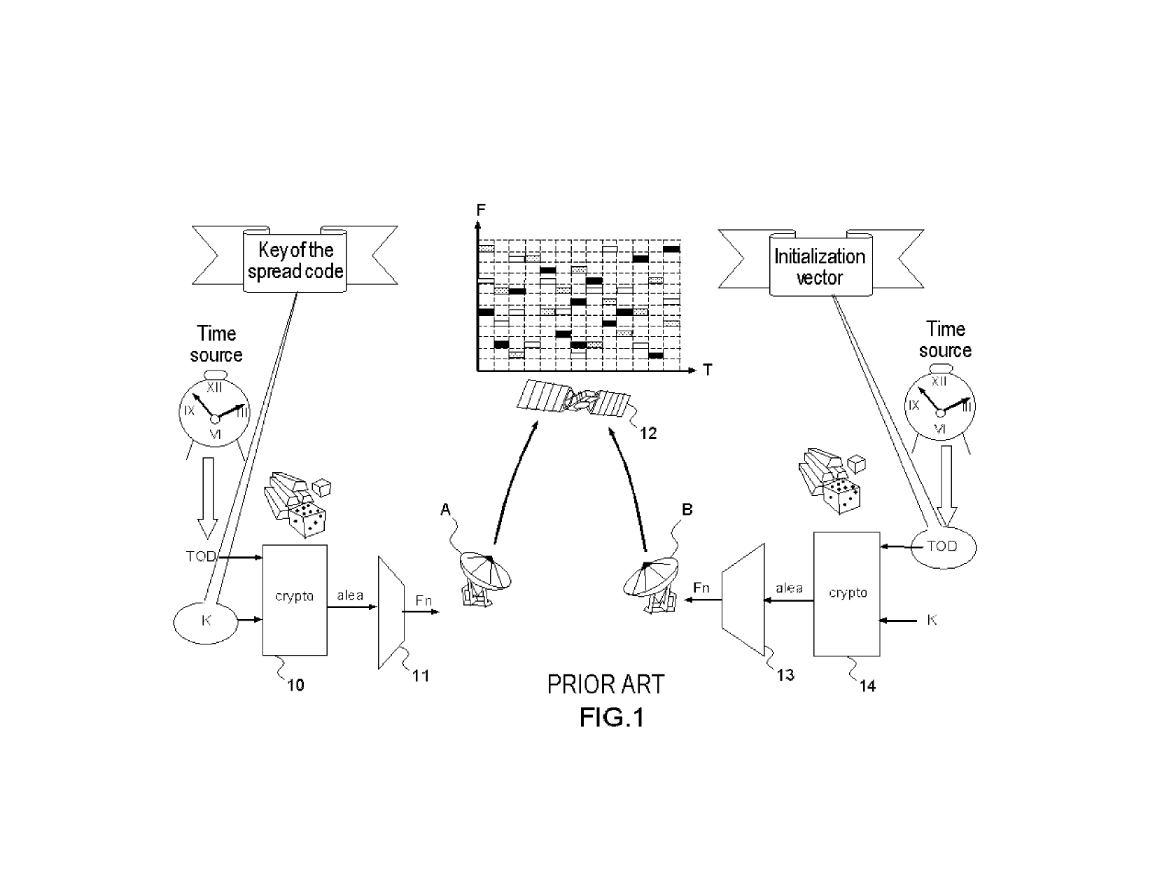

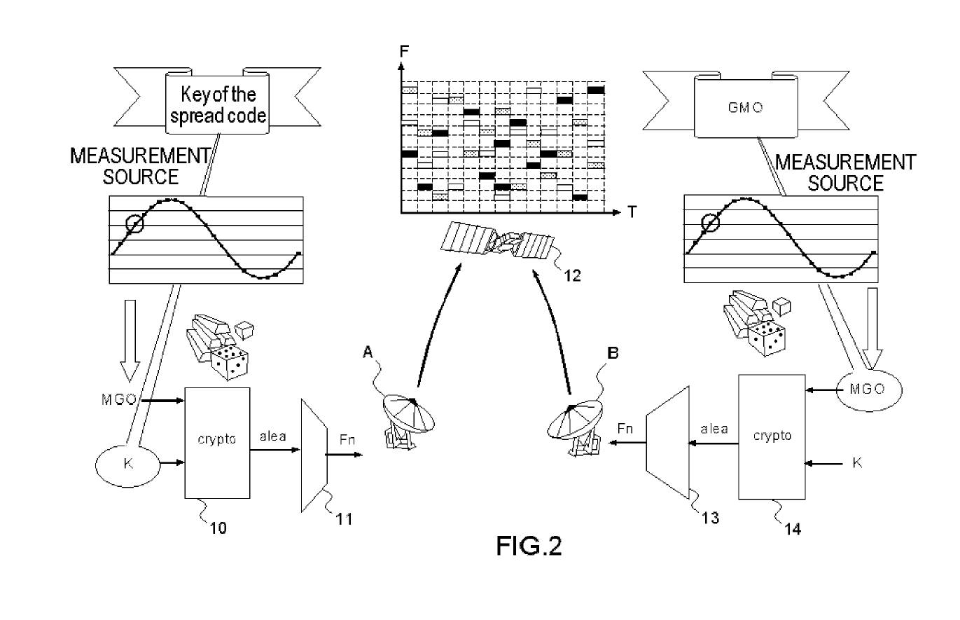

FIG. 2 reproduces the schematic of a communication network shown in FIG. 1, only the way in the which the communication is protected having changed—i.e. a counter employing a “measurable quantity” MGO is used.

In order to establish the frequency-hop function used to protect the communications, the method will define an observed measurable or calculable quantity GM that can be measured or calculated by any member of the network or by any station forming part of the network.

The MGO is for example initialized with a measured value of an observable quantity, which is measured independently by all the members of the network and at any instant. This measured quantity, after normalization, is uniform in space and variable in time according to a known function.

The MGO is then incremented by 1 after each time interval corresponding to the duration of a set of FHSS stages (“TRANSEC”). The interval Itpa corresponds to the interval between pseudo-random number generations.

The duration of the interval (Itpa) between pseudo-random number generations, which is common to the entire network, is defined, for example, in the following way: Itpa equals the required maximum value of the ratio precision/slope in units of seconds, where:
precision=that of the measurement of the measured quantity in units of metres; and
slope=the linearized time derivative of the measured quantity in units of m/s.

A station that achieves the required precision for the measurement of GM will carry out a synchronization search with a wait function, the duration of a wait stage of which is equal to Itpa. The station which has a smaller (larger, respectively) “precision/slope” ratio will possibly use a more rapid (slower, respectively) wait function.

The measurable and measured quantity is, for example, a quantity that obeys a periodic physical or natural law that does not change over the duration of the secure communications. For example, the measured quantity may obey a sinusoidal function or any Fourier series. It is necessary to know said function and its period to implement the method according to the invention.

The method according to the invention executes, for example, the following steps:
the emitting or receiving station measures an observable quantity at any instant t, to do this it uses a suitable measuring device;
the two stations independently define an initialization vector VI using the measured quantity GM after having normalized and quantified this value. Normalizing the initialization vector especially increases the uniformity of the information obtained across all the stations of the communication network. The quantification of the measurable quantity allows the discrete value to be calculated for the initialization vector; and
the emitting and receiving stations are equipped with suitable means that use an autonomous time base to count the time intervals Itpa, called the “pseudo-random number generation interval”, from the instant t corresponding to the measurement of the observable quantity. The station will increment the initialization vector by 1 after each interval, using a counter. The intervals are calculated, for example, by a processor internal to the station or modem.

Normalizing the measured quantity (GM) consists, for example, in reframing it in the [−1, +1] value field by dividing the measured value GM by the amplitude denoted “a”, which is known because the latitude of the station and the inclination of the orbit are known.

The linearized slope equals: slope=a×ω where the angular frequency ω=2π/T, where T=23 h 56′ 04″ is the orbital period.

In the case of a counter formed from a number of sub-counters, for example four cascaded sub-counters in the example given below, the sub-counter denoted cp2 is, for example, quantified in the way described below.

Thus, at the network level a time interval Itpa is defined corresponding to an incrementation by 1 of the sub-counter cp2, where Itpa=required maximum ratio of the precision of the measurement of the quantity/slope. For example, if all the stations have a ratio 10 s, depending on their geographical position and their means for measuring GM, then Itpa is taken to equal 10 s.

At the level of each station of the network, a quantum q=Itpa×a×ω is defined. After the measurable quantity (for example the station-satellite distance) has been measured to have the value GM, each station initializes its sub-counter cp2 with the following value: cp2=GM/q. This operation allows both the normalization (division by “a”) and the quantification of the quantity.

This quantum value would correspond to 200 metres for a station that observed the satellite to move with a speed of 20 m/s, if Itpa=10 s.

The emitting station in the emitting state executes a first frequency-hop function L_{A} (also called function L₁, which corresponds to the maximum hop rate). The receiving station in the synchronization-searching state executes a wait function L_{B}. The wait function also applies to the initialization vector VI. The stations will then synchronize during the transmissions in order to change frequency in unison. The function L_{B} is a sub-sample of the function L_{A} (also called function L₁), the order of which depends on the measurement precision, the duration of the pseudo-random number generation interval Itpa and the time derivative of the measured quantity.

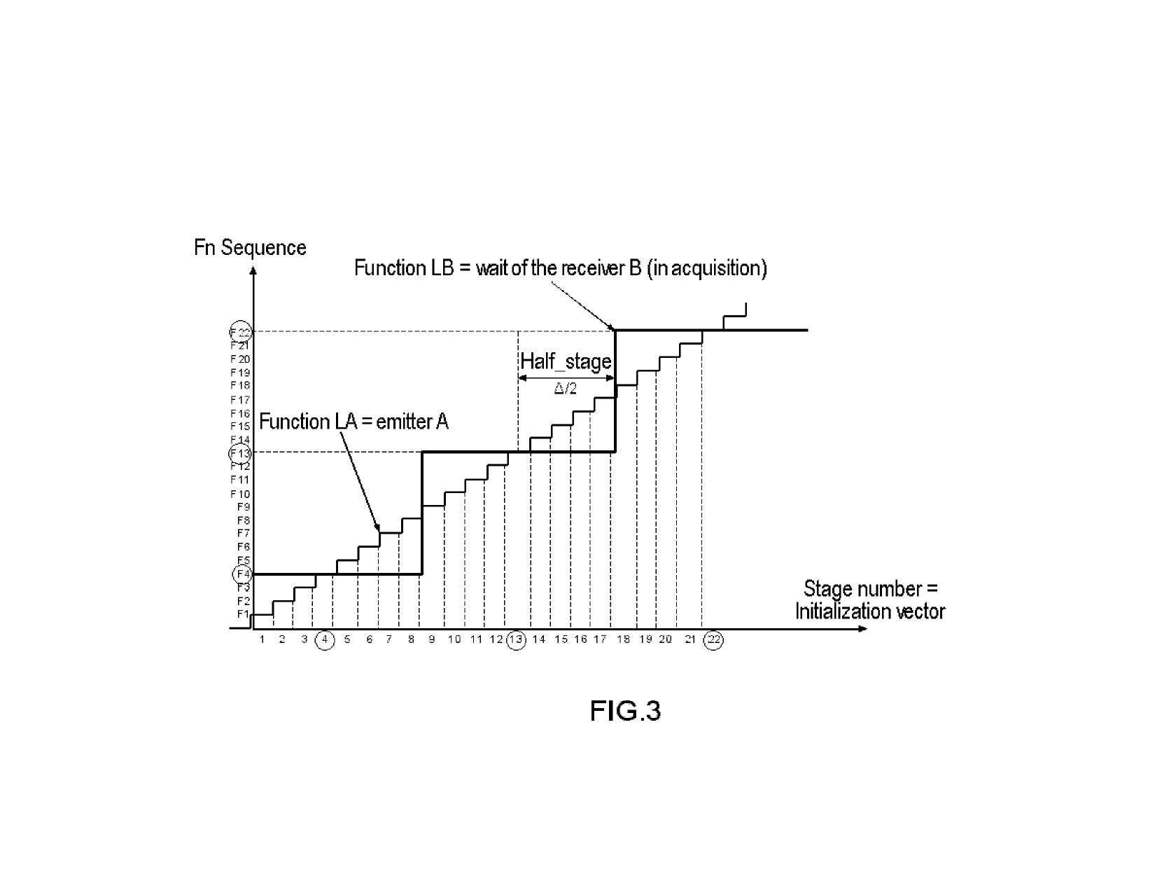

FIG. 3 shows a frequency-hopping spread spectrum or FHSS wait function, on a graph where the X-axis corresponds to the initialization vector VI. In the prior art, the X-axis represents the number of a time interval, the sequence of these intervals being numbered on a time scale, and the duration of a wait half-stage is Δ/2 where Δ/2=the uncertainty regarding the time. In the case of the present invention, the VI is the GM quantification interval number, the sequence of these intervals being numbered on a measured-quantity scale—in this figure the duration of the wait half-stage is Δ/2 where Δ/2 equals the ratio of half the measurement precision to the slope of the quantity.

The counter used to increment the initialization vector is, for example, a counter formed from four cascaded sub-counters. In order, from heavy-weight to light-weight, the first sub-counter may count the number of the orbital period, the second sub-counter the sign of variation in the measured quantity, the third sub-counter is initialized with the normalized and quantified value of the measurement, and the fourth sub-counter counts for example the stage number within a fixed time interval the duration of which corresponds to that of a stage of the wait function of the receiver.

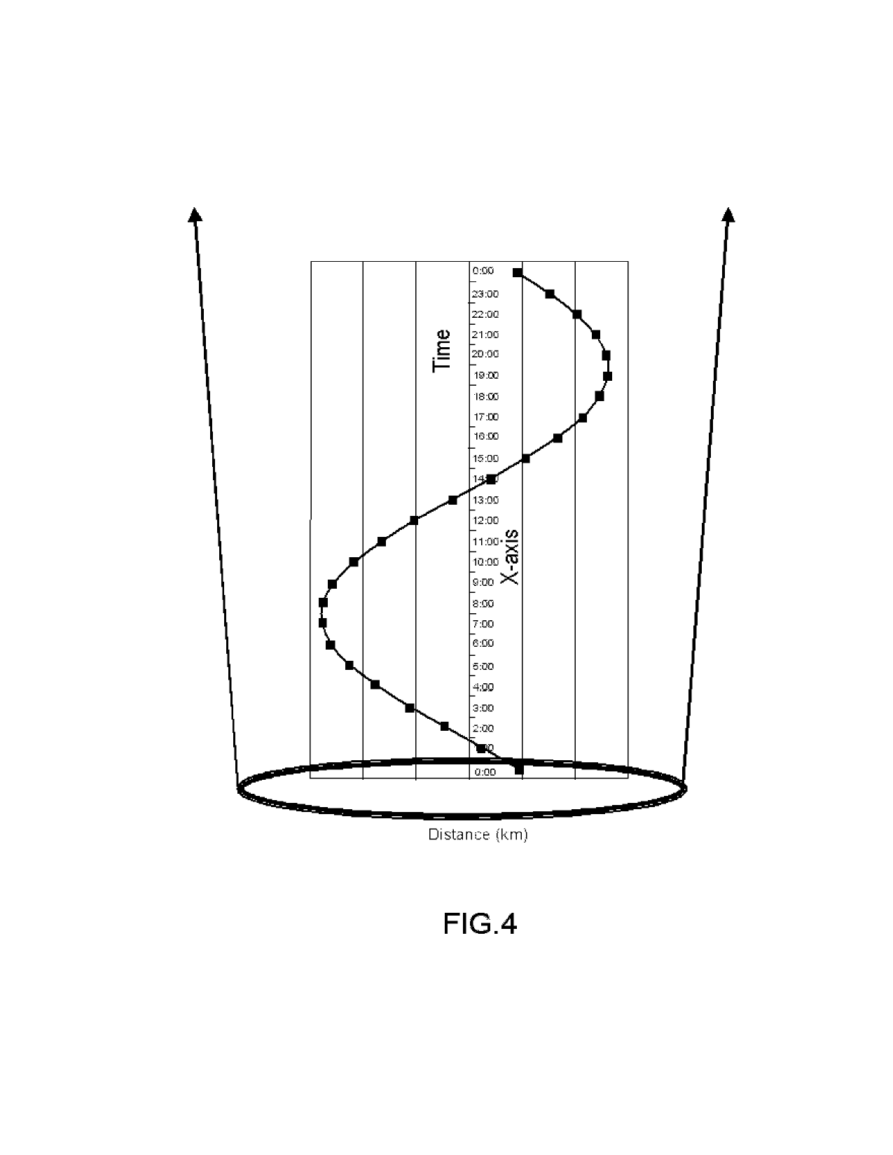

FIG. 4 shows an exemplary application of the process according to the invention to SATCOM satellite communications.

The orbital movement of the satellite is a Keplerian orbit, i.e. an ellipse osculating the true trajectory, the parameters or ephemerides of which are known.

An earth-based satellite terminal may use a highly spread discrete waveform to make a precise measurement of the station/satellite distance or its transit time TT in simple connected space.

A concrete example of this embodiment is given by way of example: an excursion of ±a=270 km (respectively 27 km) in 1 orbital period gives a linearized slope aω of about 20 m/s (respectively 2 m/s) for the quantity D, where ω is the angular frequency of the sinusoidal function of period T such that ω=2π/T. If the precision of the measurement is 200 m (respectively 20 m) and the interval Itpa is 10 seconds (or 1 s) then, knowing p the hop rate (hops per second) of the hop frequency, then a wait function L_{10×p} (or L_{1×p}) may be used for the synchronization, the acquisition time is 10 s (or 1s) after the measurement of D. The cascaded counter of the measurable quantity MGO comprises, from light- to heavy-weight:
cp1 counts the number of hops per quantum;
cp2 counts the number of quanta contained in GM;
cp3 counts from 1 to 2 depending on the sign of the slope; and
cp4 counts the number of the orbital period T=23 h 56′ 4″.

The following example is a numerical example given by way of illustration.

A mid-latitude station A which sees the satellite inclined at 3° with an amplitude a=270 km requires a measurement precision of 200 m to be able to use the wait function with a stage duration of 10 s.

If its precision is better it must respect the counter cp2 incremented by 1 after every interval Itpa, but its wait function will be faster, therefore its traffic acquisition time will be faster.

A low-latitude station B that sees the same satellite inclined with an amplitude a=27 km requires a measurement precision of 20 m to be able to use the wait function with a stage duration of 10 s.

If its precision is less, it must respect the counter cp2 incremented by 1 after every interval Itpa, but its wait function will be slower, therefore its traffic acquisition time will be slower.

The stations A and B generate the same random numbers at the same instant initializing their MGO marker with the same value.

Taking the sinusoid for example at half its amplitude i.e. +135 km for station A and +13.5 km for station B, the quantum A q(A)=200 m and the quantum B q(B)=20 m.

For the two stations A and B, the normalized and quantified value of the sub-counter cp2 is the same 135/0.2=675.

For the 10 s wait function, the value of the first sub-counter cp1 is zero. The values of the third sub-counter cp3 and the fourth sub-counter cp4 are identical for A and B.

The sub-counter cp2 is incremented by 1 over a time base Itpa=10 s defined for the network.

Thus, the stations A and B generate the same random numbers.

Suppose now that the station A gains access first then the station B gains access 10 minutes later.

Station A initialized its MGO with cp2=675 using the above method. It is assumed that its TT varies at 20 m/s. After 10′ its TT is 135 km+20×600 m=147 km. Its cp2 is 675+600/Itpa=735. The normalized quantified value would be 147/0.2=735.

Station B has a TT that varies at 2 m/s. After 10′ its TT is 13.5 km+2×600 m=14.7 km. Its cp2 has the normalized quantified value 14.7/0.02=735.

The method according to the invention especially has the following advantages: it is independent of any time source, and independent of GPS in particular, and it does not use non-ECCM or degraded ECCM emissions which would make the station vulnerable, discretization being obtained via emission of a direct-sequence spread spectrum or PN waveform, for example for the ultra-precise measurement of the distance to the satellite.

It is not necessary to transmit the initialization vector by radio.

1. A method for securing communications in a network comprising at least one emitter terminal and one receiver terminal, comprising:
defining a measurable quantity that can be measured at the emitter terminal and the receiver terminal;
normalizing and quantifying said defined quantity;
initializing an initialization vector with said normalized and quantified quantity;
using said initialization vector with a cryptographic key to randomly generate a set of consecutive frequencies to use for securing said communications between the emitter terminal and the receiver terminal; and
incrementing the initialization vector by a given value after each pseudo-random generation time interval in order to generate a set of consecutive frequency values.

2. The method according to claim 1, wherein the receiver terminal carries out a synchronization search using a wait function the duration of the wait stage of which is based on the duration of the time interval.

3. The method according to claim 1, using, as the measurable value, a function of the conventional mechanical variation in distance of a geostationary satellite inclined relative to any station located at a non-zero latitude.
